(19) United States
(12) Patent Application Publication
(10) Pub. No.: US 2018/0107462 A1
(43) Pub. Date: Apr. 19, 2018

(54) TOOL FOR RENDERING DIFFERENT USER INTERFACES

(71) Applicant: LinkedIn Corporation, Mountain View, CA (US)

(72) Inventors: Yawen Wei, Sunnyvale, CA (US); Yizhen Zhao, Pacifica, CA (US); Zhifeng Deng, Mountain VIew, CA (US); Dayun Li, Sunnyvale, CA (US)

(21) Appl. No.: 15/293,643

(22) Filed: Oct. 14, 2016

(51) Int. Cl. G06F 9/44; G06F 3/0484; G06T 11/20; G06F 3/0482

(52) U.S. Cl. CPC G06F 8/38; G06F 3/04847; G06T 2200/24; G06F 9/4443; G06F 3/0482; G06T 11/206

(57) ABSTRACT

A system and method for rendering different user interfaces are provided. In one approach, a processing component receives data that is composed by a user and that specifies one or more metrics and one or more dimensions. Based on the data, the processing component analyzes log data comprising multiple events and generates output data that specifies (1) each dimension and a dimension value associated with each dimension and (2) each metric and a metric value that is associated with each metric and that is aggregated based on the dimension(s). A user interface component generates, based on the output data, a UI that comprises multiple UI elements. Generating the UI includes (1) identifying the dimension(s) specified in the output data and generating a UI element for each dimension and (2) identifying the metric(s) specified in the output data and generating a UI element for each metric.

### TECHNICAL FIELD

The technical field relates to generating reports from analyzing log data and, more specifically, to providing a single software tool that allows users to view different types of reports regardless of the metrics and dimensions involved in the underlying report data.

### BACKGROUND

Data analysis is a process of inspecting, cleaning, transforming, and modeling data with the goal of discovering useful information, suggesting conclusions, and supporting decision-making. Without the proper tools, data analysis can be very time and labor intensive. Many enterprises that rely heavily on data analysis in order to run efficiently find it difficult to find the right personnel who are knowledgeable enough to write their own software tools for data analysis. Even with the right personnel, current approaches for analyzing data are slow and error prone. One current approach involves a user composing a Pig script that is run on a Hadoop cluster in order to read data from one or more log files and generate output. The same or different user then must be aware of how the output is formatted or structured before composing a user interface generating script (e.g., written in Python) that is configured to read the output and generate a user interface. However, such a UI generating script is only useful for output from that Pig script. For example, a Python script that is written to read only two metrics and three dimensions from an output file will not be able to read another output file that includes information about (a) a different number of metrics or dimensions or (b) the same number metrics and dimension but different types of metrics or dimensions. A different UI generating script must be written for each different Pig script.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a block diagram that depicts an example system for running scripts, in an embodiment;

FIG. 3 is a screenshot of an example user interface of the script editor, in an embodiment;

FIG. 4 is an example script that a user may compose in order to retrieve data about multiple metrics across multiple dimensions, in an embodiment;

FIG. 5 is an example board interface that allows a user to select a board from among multiple boards, in an embodiment;

FIG. 6 is a screenshot of an example report generation interface for generating one or more report messages, in an embodiment;

FIG. 7 is a diagram that depicts example report data in a report message, in an embodiment;

FIG. 8A is a screenshot of a portion of an example user interface that specifies metrics and dimensions specified in an output file, in an embodiment;

FIG. 8B is a screenshot of a portion of an example user interface that shows multiple selectable time levels within the time dimension, in an embodiment;

FIG. 9 depicts an example bar chart that shows multiple metrics over time, in an embodiment;

FIG. 10 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described for regularly running scripts and generating reports based on event data. In one technique, a system includes components for composing scripts, saving the scripts, scheduling the scripts for running against event data, storing output of the scripts, and rendering a user interface based on the output. Even though running different scripts may extract different types of data organized across different dimensions, the same rendering component is used to generate a user interface that is customized to the extracted data.

### Example Event-Generating System

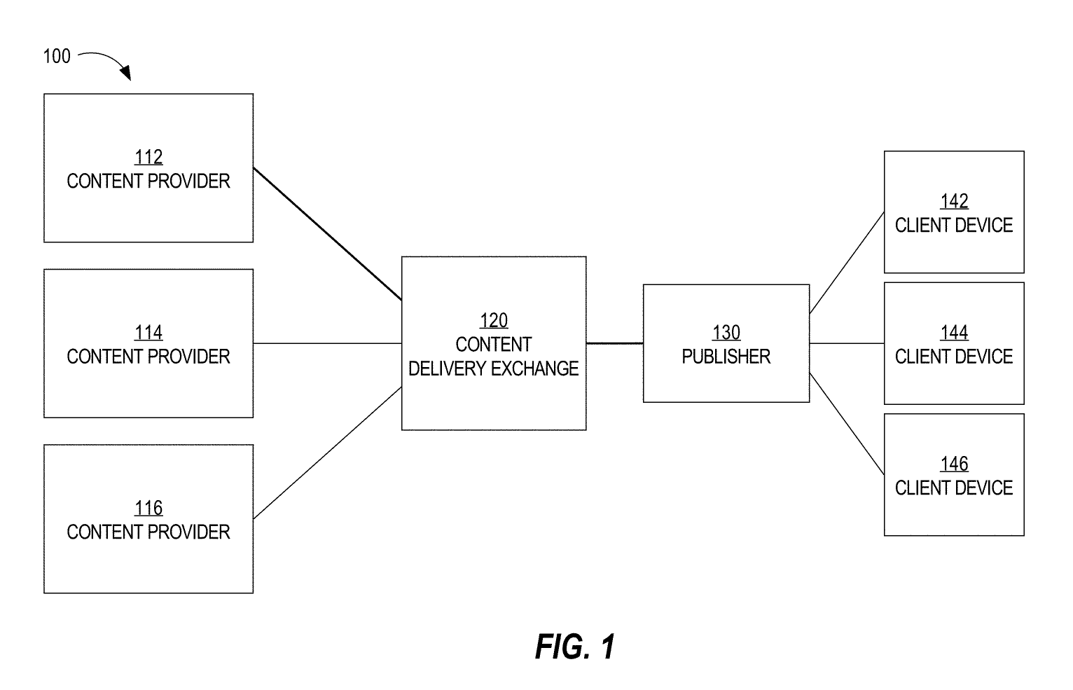

FIG. 1 is a block diagram that depicts a system 100 for distributing content items to one or more end-users, in an embodiment. While techniques described herein for generating and displaying report data includes examples in the content delivery context (such as FIG. 1), embodiments are not so limited. The types of data and event may vary from one context to another.

System 100 includes content providers 112-116, a content delivery exchange 120, a publisher 130, and client devices 142-146. Although three content providers are depicted, system 100 may include more or less content providers. Similarly, system 100 may include more than one publisher and more or less client devices.

Content providers 112-116 interact with content delivery exchange 120 (e.g., over a network, such as a LAN, WAN, or the Internet) to enable content items to be presented, though publisher 130, to end-users operating client devices 142-146. Thus, content providers 112-116 provide content items to content delivery exchange 120, which in turn selects content items to provide to publisher 130 for presentation to users of client devices 142-146. However, at the time that content provider 112 registers with content delivery exchange 120, neither party may know which specific end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery exchange 120.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content delivery exchange 120. That request is sent (over a network, such as a LAN, WAN, or the Internet) by publisher 130 or by the client device that requested the original content from publisher 130. For example, a web page that the client device renders includes one or more calls (or HTTP requests) to content delivery exchange 120 for one or more content items. In response, content delivery exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

Content delivery exchange 120 and publisher 130 may be owned and operated by the same entity or party. Alternatively, content delivery exchange 120 and publisher 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 120, and that bids for space (on one or more publishers, such as publisher 130) to present content items on behalf of multiple content providers. Thus, a bidder is another source of content items that content delivery exchange 120 may select for presentation through publisher 130. Thus, a bidder acts as a content provider to content delivery exchange 120 or publisher 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that users.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, residence information, job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 120 receives, from a computing device, a request that does not satisfy the targeting criteria, then content delivery exchange 120 ensures that any content items associated with the particular content delivery campaign are not sent to the computing device.

Instead of one set of targeting criteria, the same content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher 130 may not satisfy targeting criteria of one content item of a campaign, the same content request may satisfy targeting criteria of another content item of the campaign.

Different content delivery campaigns that content delivery exchange 120 manages may have different compensation schemes. For example, one content delivery campaign may compensate content delivery exchange 120 for each presentation of a content item from the content delivery campaign (referred to herein as cost per impression or CPM). Another content delivery campaign may compensate content delivery exchange 120 for each time a user interacts with a content item from the content delivery campaign, such as selecting or clicking on the content item (referred to herein as cost per click or CPC). Another content delivery campaign may compensate content delivery exchange 120 for each time a user performs a particular action, such as purchasing a product or service, downloading a software application, or filling out a form (referred to herein as cost per action or CPA). Content delivery exchange 120 may manage only campaigns that are of the same type of compensation scheme or may manage campaigns that are of any combination of the three types of compensation scheme.

### Tracking User Interaction

Content delivery exchange 120 tracks one or more types of user interaction across client devices 142-146. For example, content delivery exchange 120 determines whether a content item that exchange 120 delivers is displayed by a client device. Such a “user interaction” is referred to as an “impression.” As another example, content delivery exchange 120 determines whether a content item that exchange 120 delivers is selected by a user of a client device. Such a “user interaction” is referred to as a “click.” Content delivery exchange 120 stores such data as user interaction data, such as an impression data set and/or a click data set.

For example, content delivery exchange 120 receives impression events, each of which is associated with a different instance of an impression and a particular content delivery campaign. An impression event may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery exchange 120 manages multiple content delivery campaigns, then different impression events may be associated with different content delivery campaigns. One or more of these individual events may be encrypted to protect privacy of the end-user.

Similarly, a click event may indicate a particular content delivery campaign, a specific content item, a date of user selection, a time of the user selection, a particular publisher or source (e.g., onsite v. offsite), a particular client device that displayed the specific content item, and/or a user identifier of a user.

### System Overview

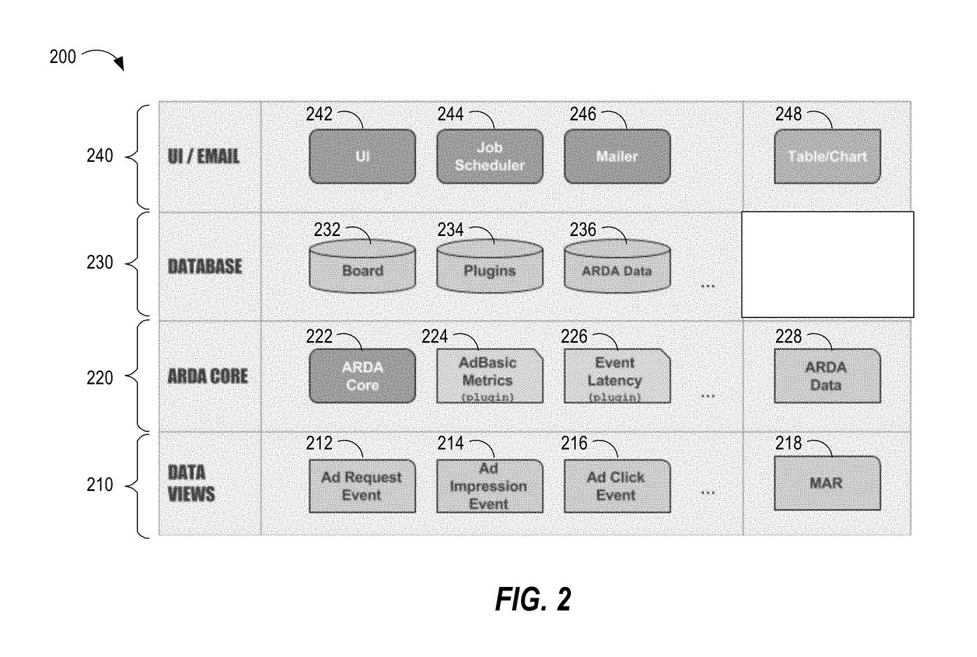

FIG. 2 is a block diagram that depicts an example system 200 for composing scripts, generating output, and displaying report data based on the output, in an embodiment. System 200 includes multiple layers: a data view layer 210, a data analysis layer 220, a database layer 230, and a user interface layer 240.

Data view layer 210 includes log data about multiple types of events: content request events, display events, and selection (or user click) events. A content request event is generated whenever a content delivery exchange (not depicted) receives, over a network, a request for content from a remote computing device, such as a laptop computer, a desktop computer, a tablet computer, a smartphone, or a third-party (e.g., bidding) service. In response to a content request, the content delivery exchange identifies one or more content items (e.g., advertisements) to send to the remote computing device (and, optionally, a bid amount). Each content item may be associated with a content delivery campaign that is established by a content provider (e.g., an advertiser). Thus, multiple content providers may interact with the content delivery exchange to establish multiple content delivery campaigns that the content delivery exchange manages. Each content delivery campaign may be associated with one or more targeting criteria that the content delivery exchange uses to determine whether the content delivery campaign should be a candidate campaign from which a content item may be retrieved. Example categories of targeting criteria include attributes of a computing device that initiated the content request, attributes of a user of the computing device, time of day, day of week, geographic location of the computing device, and information about data that will be displayed concurrently with a to-be-identified content item.

A content request event is a data item that includes data that uniquely identifies the content request from other content request (referred to herein as a “request ID”). The event may also include (if applicable) data that uniquely identifies a computing device that initiated the content request (or “device ID”), data that uniquely identifies a user of the computing device (or “user ID”, which may be the same as a member ID of a user in a social network), a time of day, a day of week, and/or a geographic location of the computing device.

A display event is a data item that indicates that a content item associated with a content request was displayed on a screen of (or at least delivered to) a computing device that initiated the content request. A browser (e.g., a third-party web browser or a dedicated client application, such as a “smartphone app”) that displays the content item generates the display event and transmits the display event to a computer system that includes system 200. A display event may include one or more of the data items contained within a content request event, such as a request ID, a user ID, a device ID, a time of day, etc.

A selection event is a data item that indicates that a user selected a content item that was displayed on a screen of (or at least delivered to) a computing device. “Selection” may refer to the user clicking on the content item with a pointer control device (“mouse”), the user pressing his/her finger to a screen on which the content item is displayed, the user placing a pointer (with a mouse) over the content item, or watching a portion of a video associated with the content item. Like a display event, a selection event may include one or more of the data items contained within a content request event.

A computer system (that includes system 200) receives and stores these or other events in storage that may comprise many storage devices, persistent, volatile, or both. For example, the events may be stored in an HDFS (or Hadoop Distributed File System).

In an embodiment, at least some events may be aggregated or joined based on a common key. For example, all events with the same request ID are combined to create a single event with all (or a subset) of the information contained in the constituent events. An example of a set of aggregated events includes MAR (or “merged ad request) 218, where each aggregated event is a combination of a content request, an impression event (that resulted from the corresponding content request), and a click event (that resulted from the corresponding content request) into a single event. Each of these “sub-events” may have the same request identifier that allows a process (e.g., in data analysis layer 220 or else) to combine the sub-events into a single event.

### System Overview: Other Layers

Data analysis layer 220 includes a script processor 222 and one or more scripts 224-226. Script processor 222 is implemented in software or any combination of software and hardware. Script processor 222 may comprise a single instance executing on a single machine or multiple instances executing on multiple machines. Script processor 222 analyzes and modifies a script 224 for execution in an execution environment that has access to data from data view layer 210. Execution of script 224 (or its modified version) results in generation of output 228.

Output 228 is stored in database layer 230, which may be separate from the storage that stores event data from which output 228 is generated. Database layer 230 includes board storage 232, script storage 234, and output storage 236 that stores output from different executions of one or more scripts.

User interface layer 240 includes a UI component 242, a scheduler 244, and a message component 246. The components in UI layer 240 may be implemented in software or any combination of hardware and software. UI component 242 reads output 228 from output storage 236 and generates a user interface 248 that includes data from output 228 (which may be stored in output storage 236). The data may include a table with multiple rows and columns, a pie chart, a line graph, and/or a bar graph.

### Scripts

A script is a program that is written for a run-time environment that automates the execution of tasks that could alternatively be executed one-by-one by a human operator. Scripting languages are often interpreted (rather than compiled). Primitives in a scripting language are usually the elementary tasks or API calls, and the language allows them to be combined into more complex programs. Environments that can be automated through scripting include software applications, web pages within a web browser, the shells of operating systems (OS), embedded systems, as well as numerous games. A scripting language can be viewed as a domain-specific language for a particular environment. In the case of scripting an application, this is also known as an extension language. Scripting languages are also sometimes referred to as very high-level programming languages, as they operate at a high level of abstraction, or as control languages.

The term “scripting language” is also used loosely to refer to dynamic high-level general-purpose languages, such as Perl, Tcl, and Python, with the term “script” often used for small programs (up to a few thousand lines of code) in such languages, or in domain-specific languages, such as the text-processing languages sed and AWK. Some of these languages were originally developed for use within a particular environment, and later developed into portable domain-specific or general-purpose languages.

An example environment in which scripts may be execute is Hadoop. Apache Hadoop is an open-source software framework for distributed storage and distributed processing of very large data sets on computer clusters built from commodity hardware. Modules in Hadoop are designed with a fundamental assumption that hardware failures are common and should be automatically handled by the framework. The core of Apache Hadoop consists of a storage part, known as Hadoop Distributed File System (HDFS), and a processing part called MapReduce. Hadoop splits files into large blocks and distributes them across nodes in a cluster. To process data, Hadoop transfers packaged code for nodes to process in parallel based on the data that needs to be processed. This approach takes advantage of data locality (nodes manipulating the data to which they have access) to allow the dataset to be processed faster and more efficiently.

### Script Editor

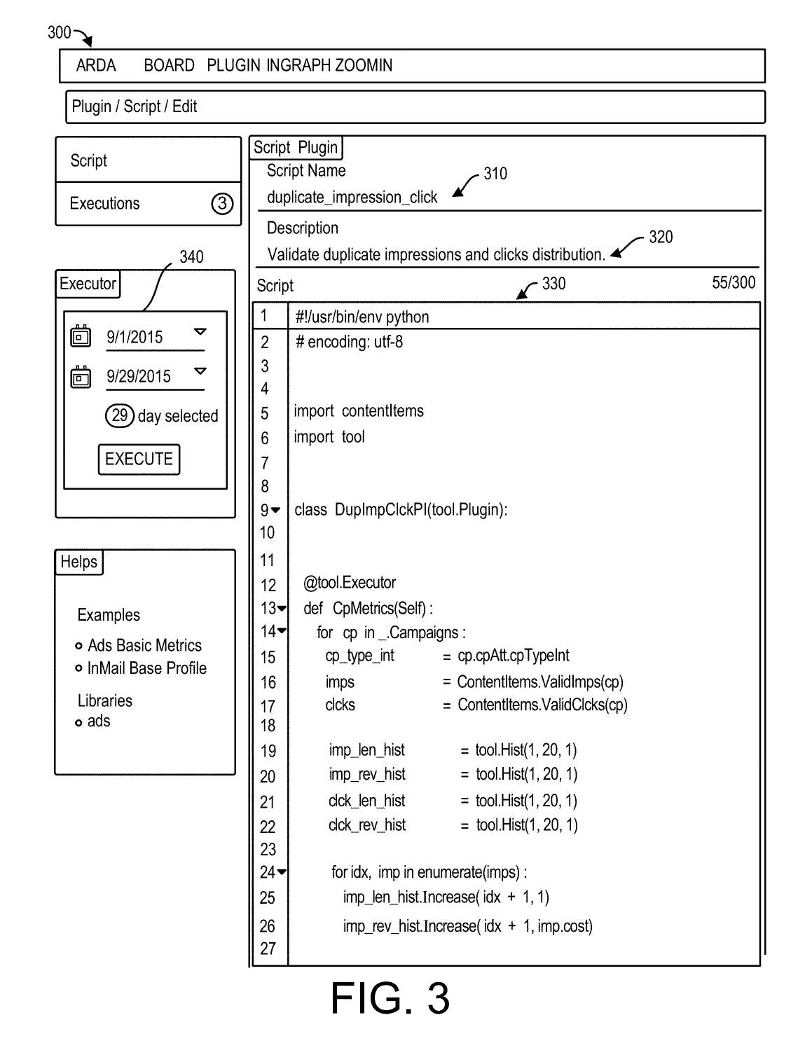

System 200 includes a script editor (not depicted) that allows a user to compose a script (or edit an existing script) that, when processed by script processor 222, generates output 228. “Scripts” may also be referred to as “plug-ins.” FIG. 3 is a screenshot of an example user interface 300 of the script editor, in an embodiment. User interface 300 includes a name field 310 for specifying a name of the script, a description field 320 for specifying a description of the output of, and/or analysis performed by, the script, a composition portion 330 for specifying the code or instructions that make up the script, and a frequency portion 340 for specifying how frequent and/or when the script will be executed. In the depicted example, a start date and an end date are specified and the script is to be executed daily within that date range.

User interface 300 may also allow a user to specify a frequency, with or without a date range. For example, a script may be executed every 6 hours within a two-month date range. As another example, a script may be executed every hour without any date range specified. Thus, with a single click, multiple executions of a script are scheduled and performed.

User interface 300 may also allow a user to specify which event data to analyze. For example, a user may specify that only event data with timestamps within a specific data range are to be analyzed or only event data with timestamps within the last 48 hours. Alternatively, the instructions within the script itself may specify which event data to analyze.

User interface 300 may include a button to save a script that is composed. The saved script may be stored in persistent storage for later retrieval and, optionally, further editing. For example, a user may select a previously-composed script (whether composed by the same user or a different user), save a new version of the script (so that the original script is left unmodified), and then modify the new version in order to create a new script for execution.

### Example Script

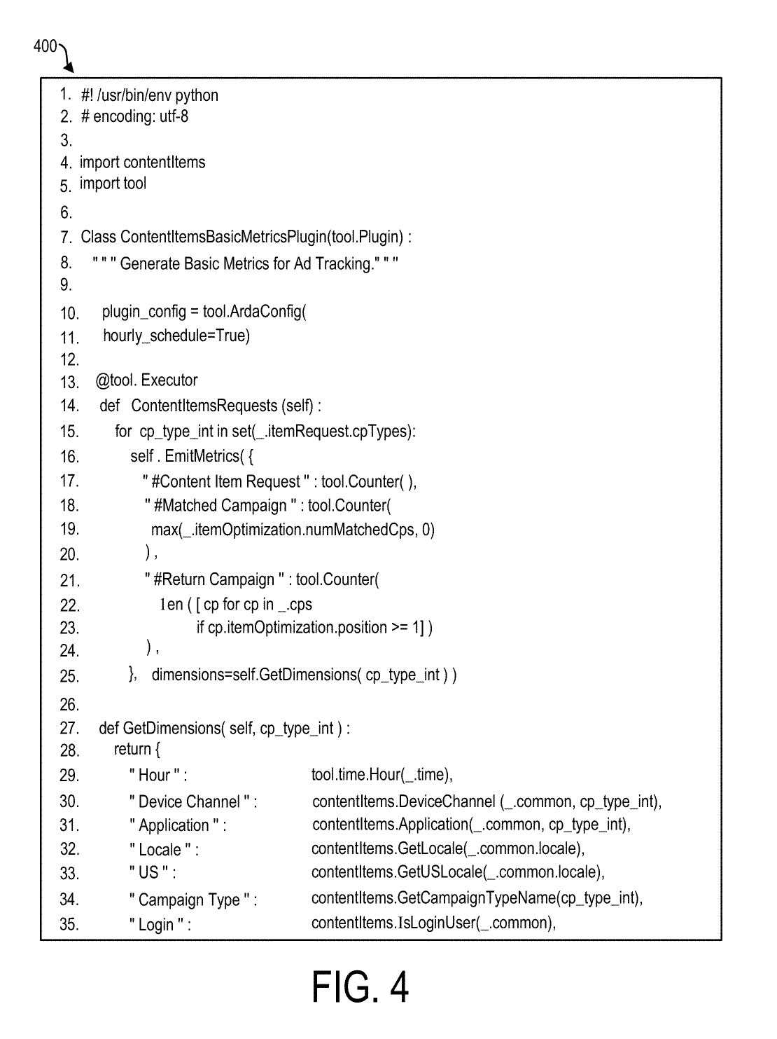

FIG. 4 is an example script 400 that a user may compose in order to retrieve data about multiple metrics across multiple dimensions, in an embodiment. Although example script 400 is written in Python, a script that script processor 222 analyzes may be in a different scripting language.

Lines 15-25 of script 400 specify three metrics: “Ad Request,” “Matched Campaign,” and “Return Campaign.” The metric “Ad Request” indicates a number of requests for ads or content items that a content delivery exchange received. The metric “Matched Campaign” indicates a number of content delivery campaigns whose targeting criteria are satisfied (at least partially) by data associated with a set of one or more content requests. For example, data associated with a content request may satisfy targeting criteria of five content delivery campaigns while data associated with another content requests may not satisfy targeting criteria of any content delivery campaign. The metric “Return Campaign” indicates a number of content delivery campaigns whose associated content items were returned in response to a set of one or more content requests. “Return Campaign” is a subset of “Matched Campaign.” For example, in response to a single content request, twenty content delivery campaigns may be identified as matching, but only content items of two of the twenty content delivery campaigns are returned to a computing device that initiated the content request. One reason why a matched campaign may not be a returned campaign is because a frequency cap of the matched campaign may be reached. Another reason may be that a selection rate (or click through rate) of the matched campaign is much lower than other matched campaigns of the same content request; therefore, it is more likely that the other matched campaigns will be selected.

Lines 27-36 of script 400 specify seven dimensions along which the three metrics may be organized and viewed. The seven dimensions in this example are “Hour,” “Device Channel,” “Application,” “Locale,” “US,” “Campaign Type,” “Login.” Example hours include each hour in a 24-hour day. Example device channels include mobile (e.g., smartphone), desktop, and tablet. “Application” refers to an application that triggered a content request. Example applications may be applications provided by a particular party or entity (such as the same party that provides the content delivery exchange) and third-party applications. “Locale” refers to a geographic location/region/country from which a content request originated. “US” refers to whether a content request originated from a computing device in the United States. “Campaign Type” refers to a type of content delivery campaign, examples of which include a text content item, a dynamic content item, and sponsored updates. “Login” refers to whether a user that is associated with a content request was logged into a computer system.

While the foregoing metrics and dimensions are relevant in the content delivery campaign context, other metrics and dimensions will be relevant in other contexts.

### Script Processor

Script processor 222 analyzes a script (e.g., script 400) to extract a portion of event data and generate output data that is in a structured format.

If the script is not in a language that is supported by the execution environment where the event data is stored, then the script is translated into another scripting language that is supported by the execution environment. For example, script processor 222 organizes the scripts as UDF in pig, a scripting language. Script processor 222 dynamically imports UDF (user-defined function) files and the pig script and, when executed in Hadoop, uploads the UDF files as jar files. If the script references avro fields, then script processor 222 may implement a translation step where avro fields in a pig tuple format are translated to named fields. Named fields are fields to which UDF can refer with an applied naming convention.

### Output

In an embodiment, output 228 includes data extracted from data view layer 210, dimension data that specifies each dimension of one or more dimensions specified in the corresponding script, and metric data that specifies one or more metrics specified in the script. The data in output 228 is organized based on the corresponding dimension(s) and corresponding metric(s) and comprises multiple output data entries. An example output data entry generated by running script 400 is one that indicates a number of content requests that (1) were received between 4 pm and 5 pm Pacific time, (2) originated on a smartphone, (3) originated from a particular news application, (4) originated from a location in the United States, (5) were for text ads, and (6) originated from logged in users.

A portion of an example output data entry may appear in output 228 as follows:

```
{
      dimensions {
            hour: 1234
            deviceChannel: Mobile
      }
      metrics {
            #AdRequests {
                  operator: COUNT, AVE, SUM
                  value: 100
            }
            #matchedCampaigns {
                  ...
            }
      }
}
```

In this example, there were 100 ad requests that were initiated by mobile devices during hour 1234, which translates to a specific date and to a specific hour on that date. In other scenarios, the “value” line may include multiple values. For example, if the operator is a weighted sum or a weighted average, then the “value” line may include a specific Value-Weight pair.

If the corresponding script specified more dimensions than hour and deviceChannel, then each of those additional dimensions may be listed in the dimension section above, along with “hour” and “deviceChannel.” “Count” is an operation that counts a number of non-zero values. “Sum” is an operation that aggregates float, integer, or other values.

Each instance of output 228 may also include script identification data that indicates which script was used to generate that instance. The script identification data may be used to identify other instances (of output 228) that were generated using the corresponding script. In this way, multiple instances of output 228 that were generated by the same script or plugin may be identified. For example, a query may request a view of all output instances generated by a particular script.

Each instance of output 228 may also include date data that indicates when the corresponding script began to be executed and/or finished executing. The date data may be used to organize multiple instances of output 228 based on this date information. For example, a query may request a view of all output instances that were generated by a particular script within a certain time period, such as the last week.

### Board Interface

In an embodiment, UI component 242 is generated through a UI tool that allows a user to select or specify a particular script, a particular time period, and/or a particular set of one or more metrics. If the particular set of metrics is not unique among all metrics specified in all scripts, then the user is displayed all relevant scripts, from which the user is able to select at least one script.

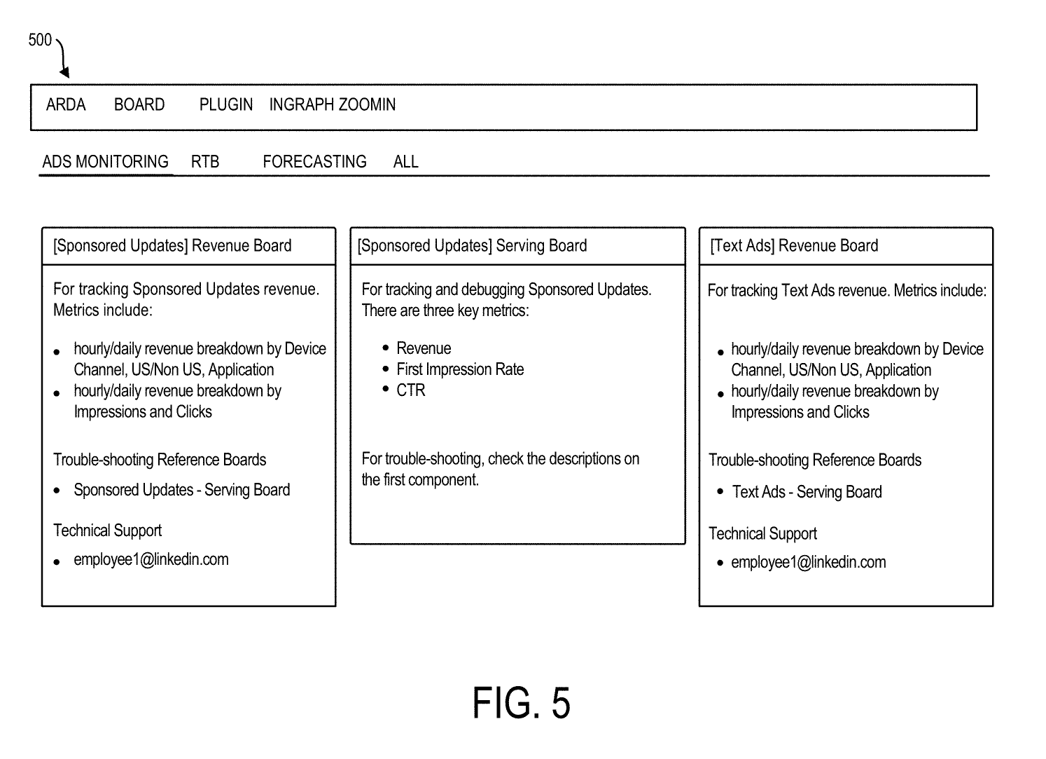

FIG. 5 is an example board interface 500 that allows a user to select a board from among multiple boards, in an embodiment. A “board” is a set of one or more instances of output generated by executing a particular script. For example, the same script may be executed daily to generate statistics related to the number of content requests that have been received the previous day. All the instances of output that is generated based on running the script correspond to the same board. While different boards may have the same set of dimensions, they may have different metrics.

In the example of FIG. 5, there are three types or categories of boards: an Ads Monitoring board, an RTB (real-time bidding) board, and a Forecasting board. Each board category includes zero or more boards. For example, the Ads Monitoring board has three boards. The category “All,” if selected, may show boards from all categories and zero or more boards that are not assigned to any category.

A category assignment may be made based on user input that, for example, “tags” or labels, a board. Alternatively, a board may be assigned a category based on a name or label in a script, such as a specific designation as a tag or a name of a metric specified in the script.

Board interface 500 indicates for each of the three depicted boards, a description of the board. Two of the boards include information about troubleshooting and a contact for technical support. Also in the depicted example, two of the boards are related to content items (or content delivery campaigns) of a first type (i.e., sponsored updates) and the other board is related to content items (or content delivery campaigns) of a second type (i.e., text ads).

### Message Component

As noted previously, user interface layer 240 includes message component 246. Message component 246 sends, to one or more recipients, messages pertaining to the results of one or more script executions. Examples of types of messages include email messages, text messages (transmitted over a cellular network), and application messages that are transmitted over a network to client applications (e.g., mobile applications) of the intended recipients.

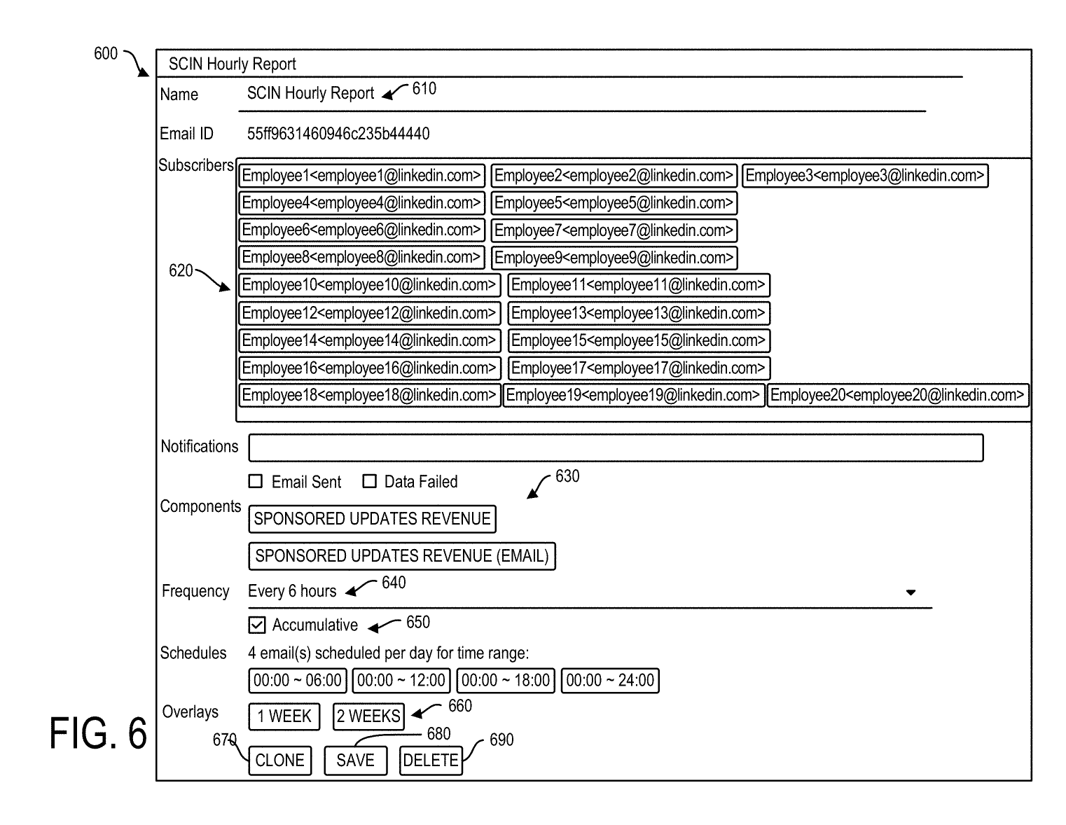

A message may be viewed as a “report” of one or more script executions. FIG. 6 is a screenshot of an example report generation interface 600 for generating one or more report messages, in an embodiment. Message component 246 may generate report generation interface 600. Report generation interface 600 contains multiple data items, including a name 610 of the report message, a name or identity of each recipient 620, one or more components 630 (or one or more UI containers, each representing a data set), a frequency 640 that indicates how often to send a report message, a accumulative checkbox 650 for indicating whether to accumulate (or combine) report data from a current script execution with report data from one or more previous script executions, overlay options 660, a clone button 670, a save button 680, and a delete button 690.

An overlay option 660, when selected, causes a report to include data from a time period that occurred prior to the current time period for which report data is being generated. In the depicted example of FIG. 6, the overlay options 660 are one week ago and two weeks ago. An overlay option, when selected, allow a user (viewing a report) to visualize the difference (if any) between current report data and previous report data. For example, a user may visually determine that current CTR is better than CTR from a week ago.

### Report Data

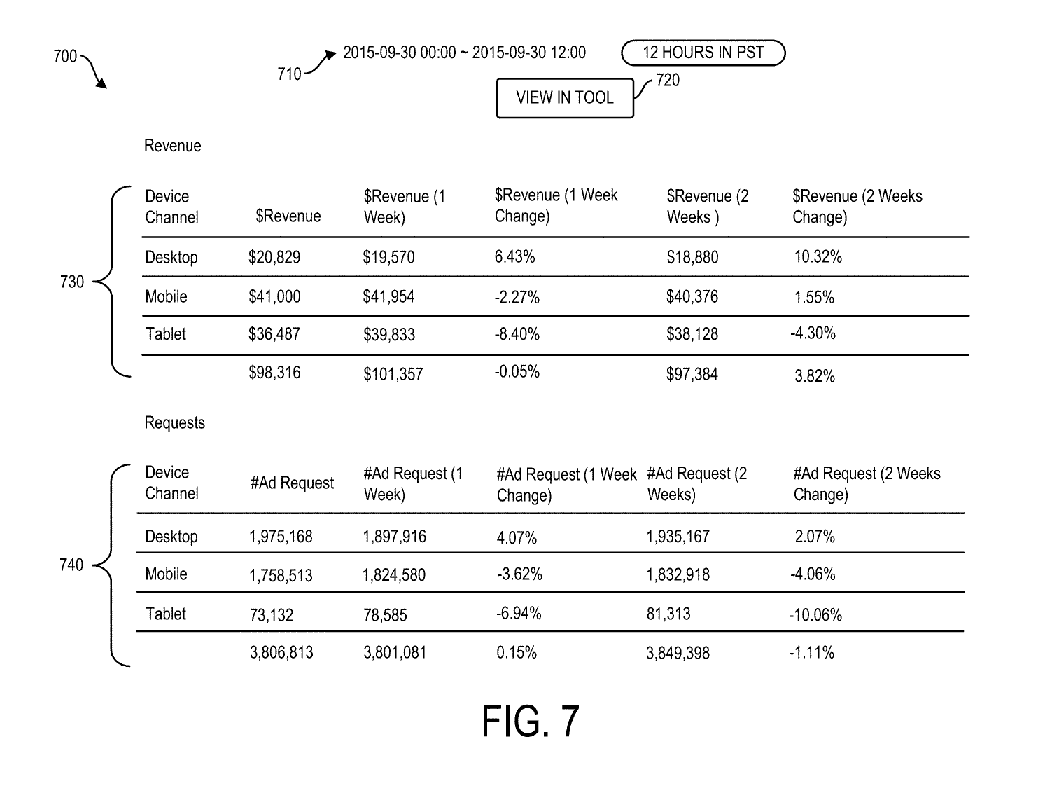

FIG. 7 is a diagram that depicts example report data 700 in a report message, in an embodiment. Report data 700 includes date and time information 710 that indicates the event data upon which the report data is based. In this example, the metrics of the report data is based on event data generated during a 12-hour period on Sep. 30, 2015.

Report data 700 may be generated by UI component 242 although report data 700 may be presented in a message (e.g., an email message) using a different application (e.g., an email client) or tool than the one that allows a user to select different dimensions and/or metrics in order to display different views of the underlying data.

Report data 700 includes two tables (730 and 740), one for each of the two metrics, which are revenue amount and number of requests. The dimension is device channel, where the types of device channel are desktop, mobile, and tablet.

Each table includes information showing metric values across the device channel dimension for different weeks, specifically one week ago and two weeks ago. Also, each table includes information showing the percentage change between previous weeks' metric values and current metric values (or metric values as of the indicated date and time information). Both of these types of metric values may be displayed in response to user selection of the overlay options in report generation interface 600 of FIG. 6.

The report message also includes a “View in ARDA” button 720 that, when selected by a user, causes a browser of the user to be directed to a web tool that displays the same information. The web tool may present an interface that allows the user to view the data differently (e.g., a bar graph) or to select different report data for viewing. For example, the interface may be board interface 500 or may include a button or link to board interface 500.

### User Interface Component

In an embodiment, UI component 242 reads output 228 and generates a user interface for display. Because each instance of output 228 specifies names of one or more metrics and names of one or more dimensions and organizes data values according to the metric(s) and dimension(s), a single instance UI component 242 is all that is needed to generate a user interface for each instance of output 228, even if different instances of output 228 specify different metrics and/or different dimensions.

Thus, a user interface that UI component 242 generates specifies the metrics and dimensions specified in the instance of output 228 upon which the user interface is based. The user interface allows users to select different dimension values and different metrics for display.

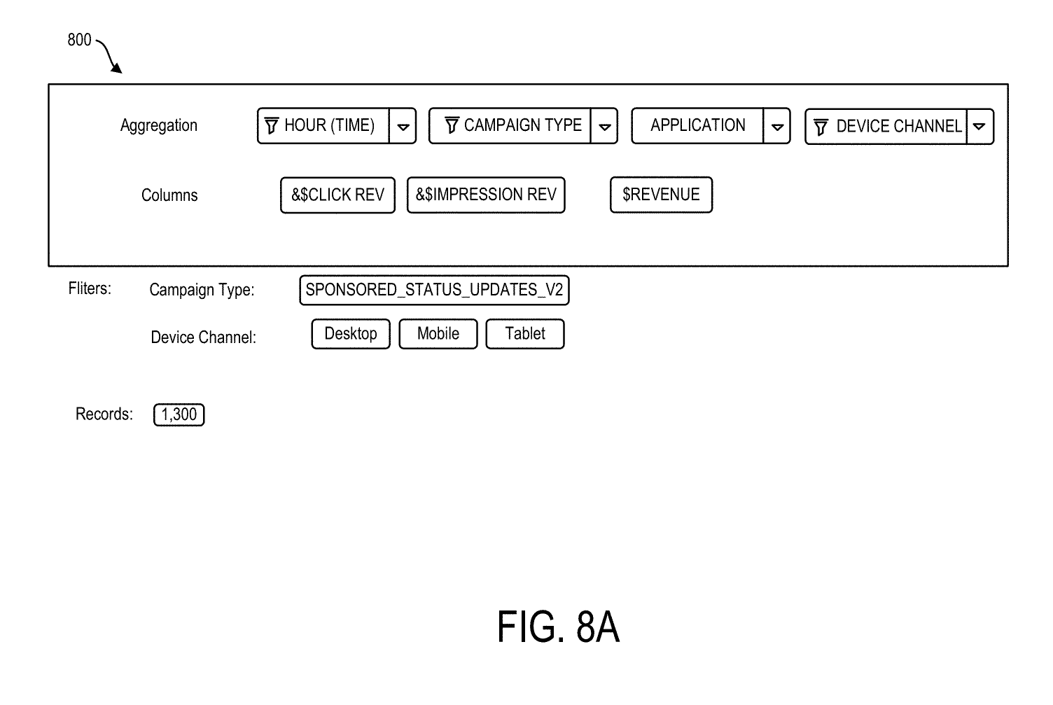

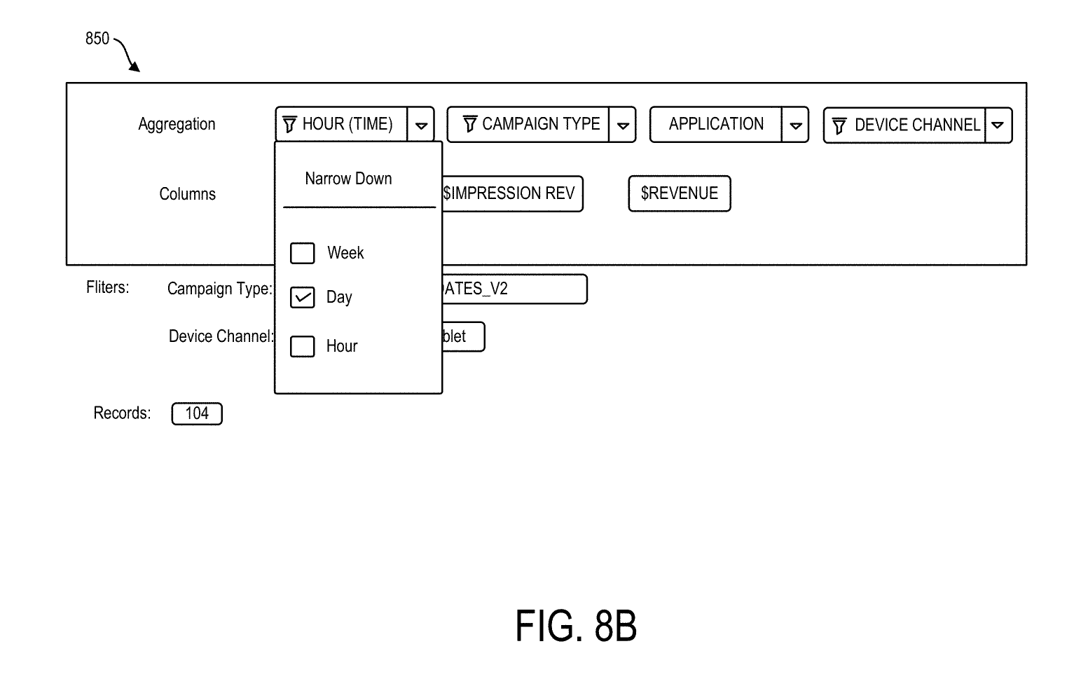

FIG. 8A is a screenshot of portion of an example user interface 800 that specifies three metrics (click revenue, impression revenue, and total revenue) and four dimensions (time, campaign type, application, and device channel). UI component 242 reads an instance of output 228 in order to identify these metrics and dimensions and presents them in user interface 800. Each UI element or button corresponding to a metric or dimension is selectable. For example, if a user selects the total revenue button, then a chart is displayed that includes one or more total revenue values, such as a single total revenue value across all values of all dimensions. UI component 242 may read and sum all total revenue values indicated in the instance(s) of output 228 upon which user interface 800 is based.

If a user then selects a dimension button, then multiple possible values corresponding to that dimension button are displayed and the user may select a subset (e.g., one or more) of those possible values. For example, if the user selects a particular campaign type, then one or more total revenue values (if the total revenue button has already been selected) are displayed in user interface 800, one total revenue value for each selected campaign type. As another example, a user is able to select mobile and tablet as device channels and, as a result, see revenue data for mobile and for table. User interface 800 also includes a “Filters” section that indicates, in this example, that device channel and campaign type have already been selected, whether by default or by user input.

The records value in user interface 800 (i.e., 1,300 in this example) indicate a number of data values from output 228 that were read in order to calculate the metric values based on the selected filters.

Depending on which metrics and dimension values are selected, UI component 242 will read a different set of data within one or more instances of output 228. For example, if no dimension values are selected and one of two possible metrics is selected, then UI component 242 reads each output data entry that specifies the selected metric, totals all metric values of the selected metric, and displays the total. As another example, if a single dimension value is selected and a single metric is selected, then UI component 242 reads each output data entry that specifies the selected metric, determines whether that output data entry also specifies the selected dimension value, and, if so, totals all the corresponding metric values of the selected metric, and displays the total. This latter example will likely be based on many fewer data entries than the former example.

As another example, if a two different values for two dimensions are selected (e.g., campaign type and channel type) and two metrics are selected, then UI component 242 reads each output data entry that specifies the selected metric, determines whether that output data entry also specifies both selected dimension values, and, if so, totals all the corresponding metric values of the selected metric, and displays the total. This latter example will likely be based on many fewer data entries than the previous examples.

In an embodiment, UI component 242 reads multiple instances of output 228, which instances are generated by different executions of the same script. For example, a first execution may correspond to one day and a second execution may correspond to log data from another day.

### Dynamic Time Scale

In an embodiment, UI component 242 generates a user interface that allows a user to re-scale the time dimension. For example, a user may see daily aggregated metric data when the underlying data in output 228 is at the hourly level. FIG. 8B is a screenshot of a portion of an example user interface 850 that shows the hour dimension button selected and three time levels: hour, day, and week. In this example, the user has selected day. Thus, UI component 242 will calculate daily metric values from hourly value a resulting chart or table (for example) will show specific days instead of specific hours.

### Chart Types

In an embodiment, UI component 242 supports (or can render) multiple types of charts. Examples of charts include line charts, bar charts, pie charts, and stream charts. Line charts are generally useful for analyzing changing trends over time or other dimensions. Bar charts are generally useful for viewing data such as counters and revenue. Pie charts are generally useful for comparing percentages or relative amounts. Stream charts are generally useful for checking percentage of time series data.

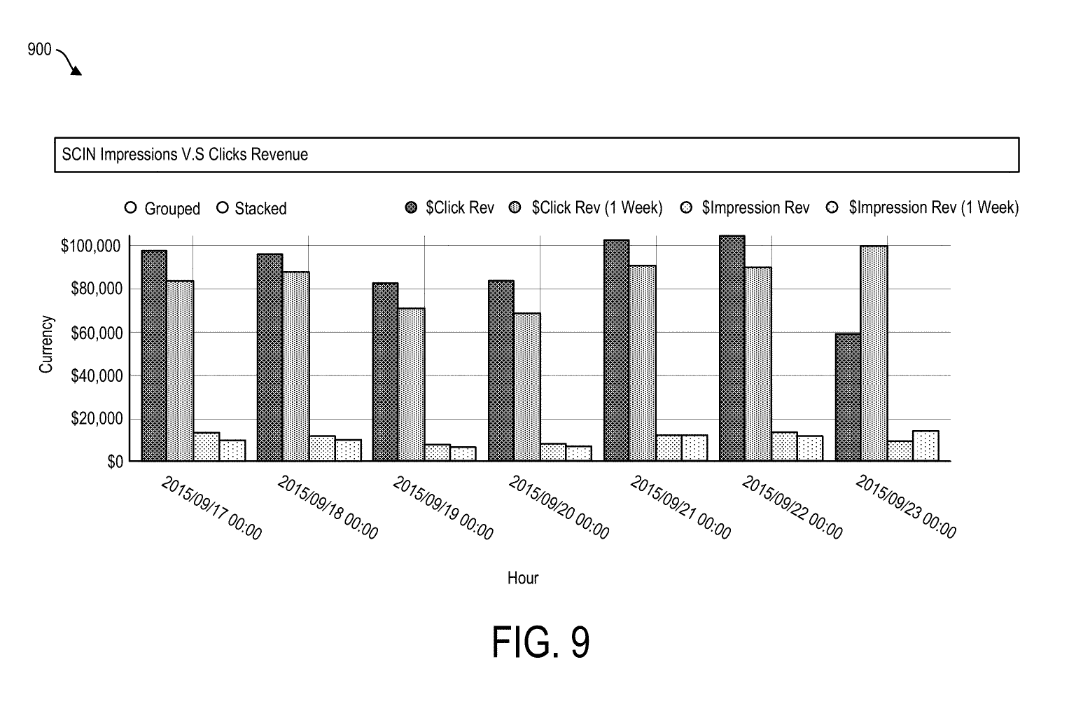

FIG. 9 depicts an example bar chart that shows multiple metrics over seven hours of a single day. The metrics include click revenue and impression revenue (e.g., based on a user selecting the click revenue button and the impression revenue button in FIG. 8A) for sponsored update campaigns (an example of a particular type of content delivery campaign), along with a one week overlay for each type of revenue indicating what the revenue was a week prior to each indicated time period.

In an embodiment, UI component 242 renders metric data in a table format, such as the tables in report data 700. In a related embodiment, UI component 242 presents an interface element that allows a user to download a table as a csv file, so that people can do further analysis using other tools, such as Excel or Pandas (which is a data analysis/manipulation library for Python).

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

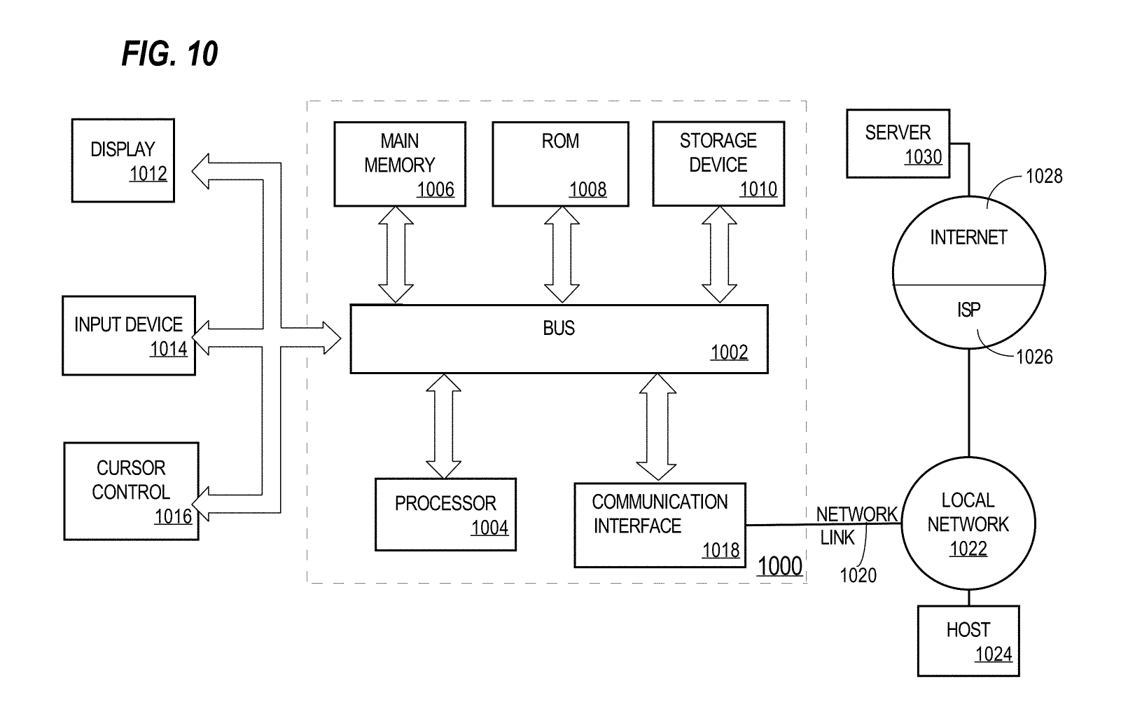

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more processors;
one or more storage media storing instructions which, when executed by one or more processors, cause:
receiving, by a processing component, first data that is composed by a user and that specifies one or more first metrics and one or more first dimensions;
based on the first data, the processing component:
analyzing first log data comprising multiple events;
generating, based on analyzing the first log data, first output data that specifies:
each dimension of the one or more first dimensions and a dimension value associated with said each dimension;
each metric of the one or more first metrics and a metric value that is associated with said each metric and that is aggregated based on the one or more first dimensions;
generating, by a user interface component, based on the first output data, a first user interface that comprises a first plurality of user interface elements, wherein generating the first user interface comprises:
identifying the one or more first dimensions specified in the first output data and generating a user interface element for each dimension of the one or more first dimensions;
identifying the one or more first metrics specified in the first output data and generating a user interface element for each metric of the one or more first metrics.

2. The system of claim 1, wherein the instructions, when executed by the one or more processors, further cause:
causing to be displayed, by a script editor component, a script interface that accepts, as input, the first data and that allows the user to specify frequency data that indicates how often to execute a program that reads the first data.

3. The system of claim 1, wherein the instructions, when executed by the one or more processors, further cause:
causing to be displayed, by a messaging component, a message interface that allows a user to specify a report name, one or more message receipts, and a frequency with which to send a report that is associated with the report name.

4. The system of claim 1, wherein the instructions, when executed by the one or more processors, further cause:
displaying user-selectable data for each board of a plurality of boards, each of which comprises multiple instances of output that were generated by multiple executions of a single script.

5. The system of claim 1, wherein the instructions, when executed by the one or more processors, cause:
receiving, by the processing component, second data that is composed by a second user and that specifies one or more second metrics and one or more second dimensions that are different than the one or more first dimensions;
based on the second data, the processing component:
analyzing second log data comprising multiple events;
generating, based on analyzing the second log data, first output data that specifies:
each dimension of the one or more second dimensions and a dimension value associated with said each dimension;
each metric of the one or more second metrics and a metric value that is associated with said each metric and that is aggregated based on the one or more second dimensions;
generating, by the user interface component, based on the second output data, a second user interface that comprises a second plurality of user interface elements, wherein generating the second user interface comprises:
identifying the one or more second dimensions specified in the second output data and generating a user interface element for each dimension of the one or more second dimensions;
identifying the one or more second metrics specified in the second output data and generating a user interface element for each metric of the one or more second metrics.

6. The system of claim 1, wherein the instructions, when executed by the one or more processors, further cause:
determining, by the user interface component, a chart type, of a plurality of chart types, in which to present a portion of the first output data, wherein the plurality of chart types includes a line chart, a pie chart, a bar chart, or a stream chart.

7. The system of claim 1, wherein the instructions, when executed by the one or more processors, further cause:
identifying a plurality of events that have a common request identifier, wherein each event in the plurality of events is of a different type of event;
creating a single record based on the plurality of events;
wherein the first log data includes the single record.

8. The system of claim 1, wherein:
the first log comprises a first set of events, each of which indicates a different instance of a display of a content item on a screen of a computing device;
the first log comprises a second set of events, each of which indicates a different instance of a selection of a content item that was displayed on a screen of a computing device.

9. The system of claim 1, wherein the one or more dimensions include two or more of time, type of content delivery campaign, type of application, type of device channel, geography, or whether a user was logged into a system when a corresponding event occurred.

10. The system of claim 1, wherein the one or more metrics include two or more of a number of requests, a number of matched content delivery campaigns, a compensation amount from impressions, a compensation amount from user selections, a total compensate amount, an impression rate, a click-through rate, or a compensation amount rate.

11. A method comprising:
receiving first data that is composed by a user and that specifies one or more first metrics and one or more first dimensions;
based on the first data, analyzing first log data comprising multiple events;
generating, based on analyzing the first log data, first output data that specifies:
each dimension of the one or more first dimensions and a dimension value associated with said each dimension;
each metric of the one or more first metrics and a metric value that is associated with said each metric and that is aggregated based on the one or more first dimensions;
generating, based on the first output data, a first user interface that comprises a first plurality of user interface elements, wherein generating the first user interface comprises:
identifying the one or more first dimensions specified in the first output data and generating a user interface element for each dimension of the one or more first dimensions;
identifying the one or more first metrics specified in the first output data and generating a user interface element for each metric of the one or more first metrics;
wherein the method is performed by one or more computing devices.

12. The method of claim 11, further comprising:
causing to be displayed a script interface that accepts, as input, the first data and that allows the user to specify frequency data that indicates how often to execute a program that reads the first data.

13. The method of claim 11, further comprising:
causing to be displayed a message interface that allows a user to specify a report name, one or more message receipts, and a frequency with which to send a report that is associated with the report name.

14. The method of claim 11, further comprising:
displaying user-selectable data for each board of a plurality of boards, each of which comprises multiple instances of output that were generated by multiple executions of a single script.

15. The method of claim 11, further comprising:
receiving second data that is composed by a second user and that specifies one or more second metrics and one or more second dimensions that are different than the one or more first dimensions;
based on the second data, analyzing second log data comprising multiple events;
generating, based on analyzing the second log data, first output data that specifies:
each dimension of the one or more second dimensions and a dimension value associated with said each dimension;
each metric of the one or more second metrics and a metric value that is associated with said each metric and that is aggregated based on the one or more second dimensions;
generating, based on the second output data, a second user interface that comprises a second plurality of user interface elements, wherein generating the second user interface comprises:
identifying the one or more second dimensions specified in the second output data and generating a user interface element for each dimension of the one or more second dimensions;
identifying the one or more second metrics specified in the second output data and generating a user interface element for each metric of the one or more second metrics.

16. The method of claim 11, further comprising:
determining, by the user interface component, a chart type, of a plurality of chart types, in which to present a portion of the first output data, wherein the plurality of chart types includes a line chart, a pie chart, a bar chart, or a stream chart.

17. The method of claim 11, further comprising:
identifying a plurality of events that have a common request identifier, wherein each event in the plurality of events is of a different type of event;
creating a single record based on the plurality of events;
wherein the first log data includes the single record.

18. The method of claim 11, wherein:
the first log comprises a first set of events, each of which indicates a different instance of a display of a content item on a screen of a computing device;
the first log comprises a second set of events, each of which indicates a different instance of a selection of a content item that was displayed on a screen of a computing device.

19. The method of claim 11, wherein the one or more dimensions include two or more of time, type of content delivery campaign, type of application, type of device channel, geography, or whether a user was logged into a system when a corresponding event occurred.

20. The method of claim 11, wherein the one or more metrics include two or more of a number of requests, a number of matched content delivery campaigns, a compensation amount from impressions, a compensation amount from user selections, a total compensate amount, an impression rate, a click-through rate, or a compensation amount rate.
